(19) United States
(12) Patent Application Publication
(10) Pub. No.: US 2024/0174101 A1
(43) Pub. Date: May 30, 2024

(54) HOUSING AND CHARGING STATION COMPRISING SUCH A HOUSING

(71) Applicant: ads-tec Energy GmbH, Nürtingen (DE)

(72) Inventors: Andreas GREIF, Weilheim (DE); Roman MOLCHANOV, Neckartenzlingen (DE)

(21) Appl. No.: 18/511,282

(22) Filed: Nov. 16, 2023

(30) Foreign Application Priority Data
Nov. 24, 2022 (DE) 102022131176.7

(51) Int. Cl. B60L 53/30; H02J 7/00

(52) U.S. Cl. CPC B60L 53/30; H02J 7/0042

(57) ABSTRACT

The invention relates to a housing, in particular for a charging station, comprising at least one cladding element and a door element, whereby
the at least one cladding element has a door lock comprising at least two locking elements, whereby
the at least two locking elements are spaced apart from one another and are arranged on the at least one cladding element so as to be capable of being rotated about a respective fastening element by means of the respective fastening element, whereby
on a first end of the respective locking element, the at least two locking elements have a latching element, whereby
the at least two locking elements are mechanically connected to one another via at least one first rigid coupling element, whereby
the at least two locking elements can in each case be displaced between a release position and a locking position, whereby
the door element has at least two locking bolts, whereby
in the locking position, the at least two locking elements engage by means of the respective latching element with a respective locking bolt of the at least two locking bolts, so that the door element is fixed relative to the cladding element, and whereby
   in the release position, the at least two locking elements release the respective locking bolt, so that the door element can be displaced relative to the cladding element.

### CROSS REFERENCE TO RELATED APPLICATION

This application claims priority to and the benefit of German Patent Application No. 102022131176.7 filed on Nov. 24, 2022, the entire contents of which are incorporated herein by reference.

The invention relates to a housing and a charging station comprising such a housing.

Housings, in particular for control cabinets and/or server cabinets, are known, which have a locking device, which is integrated into a door element of the housing. In the closed state, the locking device engages by means of at least one locking element with a cladding of the housing in order to fix the door element relative to the cladding of the housing. The disadvantage of this is that only small closing forces can be realized by means of such a locking device. Advantageously, it is furthermore necessary in a disadvantageous manner to push the door element against the cladding by means of an external force when locking the door element in order to tightly close the housing.

The invention is thus based on the object of creating a housing and a charging station comprising such a housing, whereby the mentioned disadvantages are at least partially eliminated, preferably avoided.

The object is solved in that the present technical teaching is provided, in particular the teaching of the independent claims as well as of the embodiments disclosed in the dependent claims and the description.

The object is solved in particular in that a housing, in particular for a charging station, comprising at least one cladding element and a door element is created. The at least one cladding element has a door lock comprising at least two locking elements. The at least two locking elements are spaced apart from one another and are arranged on the at least one cladding element so as to be capable of being rotated about the respective fastening element by means of a respective fastening element.

On a first end of the respective locking element, the at least two locking elements furthermore have a latching element. The at least two locking elements are mechanically connected to one another via at least one first rigid coupling element.

The at least two locking elements can additionally each be displaced between a release position and a locking position. The door element furthermore has at least two locking bolts, whereby, in the locking position, the at least two locking elements engage by means of the respective latching element with a respective locking bolt of the at least two locking bolts, so that the door element is fixed relative to the cladding element. In the release position, the at least two locking elements release the respective locking bolt, so that the door element can be displaced relative to the cladding element. Advantageously, it is thus possible to lock the door element by means of a high closing force—in particular at least 1.3 kN. Advantageously, it is furthermore possible to pull the door element in particular tightly towards the cladding element by means of the at least two locking elements and to thus tightly close the housing. The at least two locking elements are advantageously additionally displaced simultaneously between the release position and the locking position by means of the first rigid coupling elements, in particular imparted via the first rigid coupling element.

The door element is thus in particular free from the locking device and free from the at least two locking elements. Advantageously, it is thus possible to arrange a display device in the door element, whereby the display device can in particular engage over a large portion of a surface of the door element, in particular virtually the entire surface of the door element. The display device can in particular engage over the surface of the door element, except for narrow edge regions. The display device in particular takes up at least 75%, preferably at least 80%, preferably at least 85%, particularly preferably at least 89%, of the surface of the door element. This in particular becomes possible in that the manufacturing device and the at least two locking elements are not provided on the door element.

In one design, the door element has a frame, which is in particular formed to be slim, and the display device, whereby the at least two locking bolts are arranged in the frame.

The at least two locking elements are in particular arranged vertically—that is, in particular in geodetic vertical direction—offset from one another on the at least one cladding element.

In one design, the at least two locking elements are arranged in the cladding element—in particular in the locking recesses of the cladding element, which are open towards the door element—in such a way that the at least two locking elements protrude beyond the cladding element in the direction of the door element—in particular neither in the release position nor in the locking position. Advantageously, it can thus be ensured that, when the door element is open, a user does not get stuck on the at least two locking elements. For locking purposes, the locking bolts of the door element are received in the locking recesses.

In one design, the locking bolts are arranged in a frame of the door element.

In one design, the door lock has three locking elements. The three locking elements are spaced apart from one another and are arranged on the at least one cladding element so as to be capable of being rotated about the respective fastening element by means of a respective fastening element.

According to a further development of the invention, it is provided that the at least one first rigid coupling element is in each case connected to a second end of the respective locking element, which is located opposite the first end of the respective locking element. A first distance between the first end of the respective locking element and the assigned fastening element is thereby in each case smaller than a second distance between the second end of the respective locking element and the assigned fastening element. Advantageously, the at least two locking elements thus act as lever, whereby a locking force, which is applied to the first rigid coupling element, for locking the door element is smaller than the closing force, which is in particular applied to the latching element.

In particular the following equation applies for the locking force F_{V}

$${F}_{V} = \frac{{d}_{1}}{{d}_{2}} \cdot {F}_{S} ,$$

whereby d₁ identifies the first distance, d₂ the second distance, and F_{S} the closing force. Due to the fact that the first distance d₁ is smaller than the second distance d₂, what applies is d₁/d₂<1 and the locking force F_{V} is thus smaller than the closing force F_{S}, what in particular applies is F_{V}<F_{S}.

In one design, the first distance d₁ is 82.4 mm. The second distance d₂ is additionally 160 mm. A first translation of the locking element of 82.4/160=0.515 thus results. The closing force F_{S} thus corresponds approximately to twice the locking force F_{V}.

According to a further development of the invention, it is provided that the at least one cladding element additionally has a door handle device. At least one of the locking elements and the door handle device are thereby mechanically connected to one another via at least one second rigid coupling element. The at least one first coupling element and the at least one second coupling element are connected to one another in such a way that a translation of the at least one second coupling element effects a translation of the at least one first coupling element. Advantageously, it is easily possible by means of the door handle device to displace the at least two locking elements between the release position and the locking position.

In a first embodiment, the second rigid coupling element is directly connected mechanically to the at least one locking element assigned to it, whereby it is articulated on the locking element in particular on the second end at a second point of articulation, which is offset from a first point of articulation of the first rigid coupling element, or at the same first point of articulation as the first rigid coupling element. In a second embodiment, the second rigid coupling element is indirectly connected mechanically to the at least one locking element assigned to it via the first rigid coupling element, whereby it is in particular directly connected mechanically to the first rigid coupling element.

In one design, the at least one cladding element has the door handle device, and the at least two locking elements are additionally formed in such a way that the first distance is smaller than the second distance. Advantageously, the locking force, which has to be applied by means of the door handle device in order to lock the door element, is thus smaller than the closing force for locking the door element.

According to a further development of the invention, it is provided that the door handle device has a door handle, whereby the door handle is pivotably arranged in the door handle device. The door handle is additionally connected to the at least one second coupling element in such a way that a pivoting of the door handle effects a translation of the at least one second coupling element.

In one design, the second rigid coupling element is connected to a connecting element of the door handle device, in particular directly articulated to the connecting element at a third point of articulation. The door handle is furthermore connected to the connecting element, in particular directly fastened rigidly to the connecting element at a fastening point. The door handle is thus connected to the second rigid coupling element, in particular imparted via the connecting element. The connecting element is furthermore arranged on the door handle device so as to be capable of being rotated about the fastening point. The connecting element and the door handle are in particular rigidly connected to one another in such a way that a pivoting of the door handle effects a rotation of the connecting element.

The connecting element is in particular formed and is connected to the second rigid coupling element on the one and to the door handle on the other hand in such a way that the connecting element advantageously acts as lever—in particular together with the second rigid coupling element as toggle lever—whereby the locking force, which acts on the second rigid coupling element, for locking the door element is larger than a pivot force—which is in particular introduced manually into the door handle—which is applied for pivoting the door handle. This will be validated below on the basis of a simplified illustration: In particular, the following equation applies for the pivot force F_{G}

$${F}_{G} = \frac{{d}_{3}}{{d}_{4}} \cdot {F}_{V} ,$$

whereby d₃ identifies a third distance between the third point of articulation and the fastening point, d₄ identifies a fourth distance between the fastening point and a gripping position on the door handle, and F_{V} identifies the locking force. Due to the fact that the third distance d₃ is smaller than the fourth distance d₄, what applies is d₃/d₄<1 and the pivot force F_{G} is thus smaller than the locking force F_{V}, what in particular applies is F_{G}<F_{V}.

The locking element and the connecting element in particular form a multi-stage gear, whereby in particular the occurring lever forces—in particular assuming the preceding simplified illustration—are multiplied. In particular the following equation thus applies for the pivot force F_{G}

$${F}_{G} = \frac{{d}_{3}}{{d}_{4}} \cdot {F}_{V} = \frac{{d}_{3}}{{d}_{4}} \cdot \frac{{d}_{1}}{{d}_{2}} \cdot {F}_{S} ,$$

whereby d₁/d₂<1 and d₃/d₄<1 applies and the pivot force is thus smaller than the closing force, in particular F_{G}<F_{S}.

The third distance d₃ is in particular 32.5 mm.

In the case of a fourth distance d₄ of 120 mm, the following rough calculation thus follows: A second translation of the connecting element of 32.5/120≈0.3 follows. The pivot force F_{G} thus corresponds to approximately 30% of the locking force F_{V}. A second total gear ratio of the locking element and of the connecting element of (32.5/120)·(82.4/160)≈0.3·0.5=0.15 furthermore follows for the multi-stage gear. The pivot force F_{G} thus corresponds to approximately 15% of the closing force F_{S}. In the case of a closing force F_{S} of 1.3 kN, a pivot force F_{G} of approximately only 0.2 kN thus has to be applied. The pivot force F_{G} is thus intensified approximately by the factor of 7.

The connecting element in particular does not have a play—in particular relative to the door handle and/or to the second rigid coupling element. The connecting element is in particular arranged in the door handle device in a play-free manner.

In one design, the door handle is formed in such a way that the door handle can be locked in place in the door handle device.

In addition, the door handle device in particular has a closing device, whereby the closing device is formed in such a way that the housing can be locked, when the locking elements are in the locking position. It can thus advantageously be ensured that the housing, in particular the door element, cannot be opened by unauthorized third parties. The housing can in particular be locked when the door handle is locked in place in the door handle device.

According to a further development of the invention, it is provided that the door handle can be displaced between a door release position and a door locking position. During a pivoting of the door handle from the door locking position into the door release position, the at least two locking elements are in each case rotated from the locking position into the release position.

A pivot angle of the door handle between the door locking position and the door release position is in particular at least 100°, preferably at least 110°, preferably at least 120°, preferably at least 130°, preferably at least 140°, preferably at least 150°, preferably at least 160°, particularly preferably at least 165°, in particular maximally 180°, in particular maximally 175°, in particular maximally 170°.

In the door locking position, the door handle can in particular be locked in place in the door handle device.

According to a further development of the invention, it is provided that the second coupling element is fastened to the door handle device in such a way that a point of articulation—in particular the fourth point of articulation—of the second coupling element on the door handle device is arranged in a beyond dead center position when the door handle is arranged in the door locking position. It can advantageously be ensured therewith that the door handle is held in the door locking position automatically and without an external force. Due to the beyond dead center (over-center) position, the door handle is advantageously in particular pushed into the door locking position—in particular by an elastic door seal imparted via the locking elements as well as the rigid coupling elements—when the point of articulation—in particular the fourth point of articulation—is pivoted above the beyond dead center position by means of the door handle.

The object is also solved in that a charging station comprising a housing according to the invention or a housing according to one or several of the above-described embodiments is created. In particular the advantages, which have already been described in connection with the housing, result in connection with the charging station.

The charging station is in particular formed as a charging station for electric vehicles.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance the traction battery of an electric vehicle—is referred to as charging station. Charging stations for electric vehicles are sometimes also referred to as “electricity charging stations” and can comprise several charging points. In particular direct current quick charging systems (high performance charging systems or high-power charging systems, HPC systems) such as the so-called combined charging system (CCS), which is common in Europe, are known here. During the generic direct current charging, direct current from the charging station is fed directly into the battery of the vehicle and is, for this purpose, provided to, e.g., solar charging stations by means of a powerful rectifier, preferably of the charging station, from the power supply or by means of large buffer accumulators. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding connections of the traction battery, high charging currents can be transferred with little loss, which provides for short charging times.

In one embodiment, the charging station is formed as a charging column. The charging station in particular has at least one charging point, in particular exactly one charging point or exactly two charging points.

The charging station is in particular formed as quick charging station. In one embodiment, the charging station is formed as battery-supported charging station, in particular as battery-supported quick charging station.

The invention will be described in more detail below on the basis of the drawing, in which:

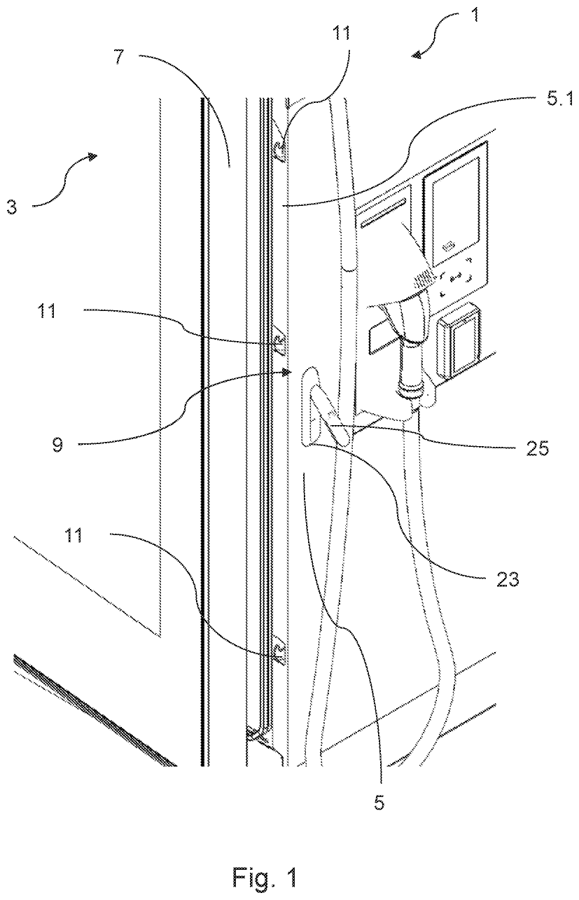

FIG. 1 shows a schematic illustration of an exemplary embodiment of a charging station with an exemplary embodiment of a housing,

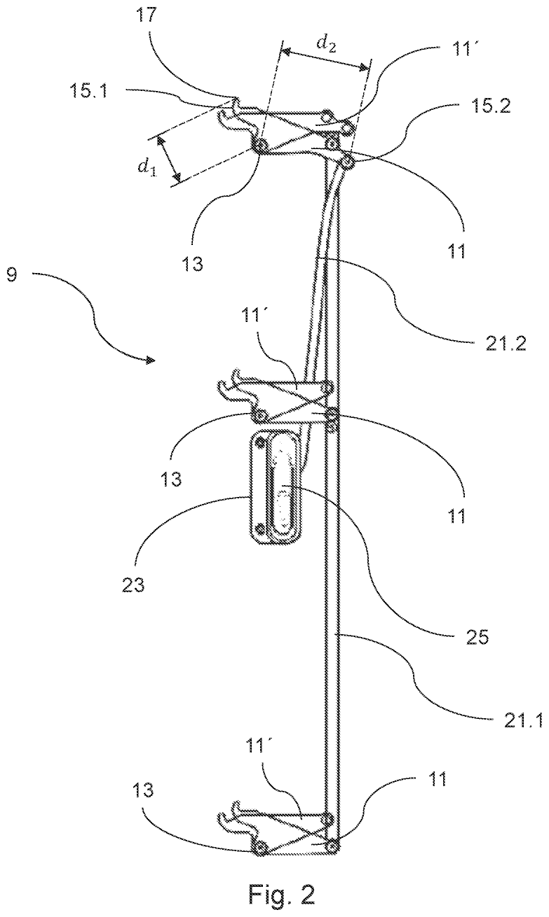

FIG. 2 shows a schematic illustration of an exemplary embodiment of a door locking device,

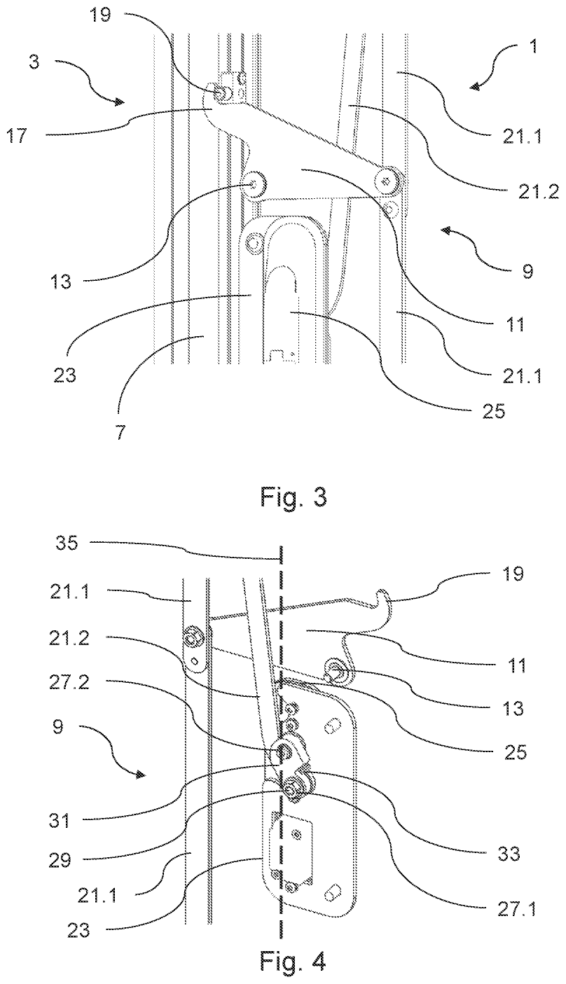

FIG. 3 shows a schematic illustration of a detail view of the exemplary embodiment of the charging station, and

FIG. 4 shows a schematic illustration of a detail view of the exemplary embodiment of the door lock.

FIG. 1 shows a schematic illustration of an exemplary embodiment of a charging station 1 comprising an exemplary embodiment of a housing 3. The charging station 1 is in particular formed as a charging station 1 for electric vehicles 1. In particular, the charging station 1 is additionally formed as a battery-supported charging station, in particular as an in particular battery-supported quick charging station. The housing 3 has at least one cladding element 5 and a door element 7.

The at least one cladding element 5 has a door lock 9 comprising at least two locking elements 11, in particular comprising three locking elements 11. The at least two locking elements 11 are spaced apart from one another, in particular vertically spaced apart from one another, and are arranged on the at least one cladding element 5 so as to be capable of being rotated about the respective fastening element 13 by means of a respective fastening element 13, which is illustrated in FIGS. 2 to 4. On a first end 15.1 of the respective locking element 11, the at least two locking elements 11 furthermore have a latching element 17, which is provided with a reference numeral only in

FIGS. 2 to 4 for the sake of a more clear illustration. The further design of the door lock 9 is illustrated in FIGS. 2 to 4.

The at least two locking elements 11 are preferably arranged in the cladding element 5 in such a way that the at least two locking elements 11 do not protrude beyond the cladding element 5, in particular a side part 5.1 of the cladding element 5, in the direction of the door element 7.

The door element 7 furthermore has at least two locking bolts 19, in particular three locking bolts 19, whereby one locking bolt 19 is illustrated in FIG. 3. The at least two locking bolts 19 are preferably arranged in a frame of the door element 7.

The locking bolts 19 and the locking elements 11 are formed in such a way that a respective latching element 17 can come into engagement with a respective locking bolt 19, in order to fix the door element 7 relative to the cladding element 5.

In addition, the at least one cladding element 5 preferably has a door handle device 23. In addition, the door handle device 23 preferably has a door handle 25, whereby the door handle 25 is pivotably arranged in the door handle device 23.

FIG. 2 shows a schematic illustration of the exemplary embodiment of the door locking device 9 from FIG. 1. The cladding element 5 and the door element 7 is in particular hidden in FIG. 2.

Identical and functionally identical elements are provided with the same reference numerals in all figures, so that reference is made to the preceding description in this respect.

For a clearer illustration, a latching element 17 is provided with a reference numeral only in the case of one locking element 11. All locking elements 11 are formed analogously to one another.

In FIG. 2, the locking elements 11, 11′ are furthermore illustrated in a release position, in particular identified with the reference numeral 11′, as well as in a locking position, in particular identified with the reference numeral 11.

The at least two locking elements 11, 11′ are connected to one another mechanically via at least a first rigid coupling element 21.1. In addition, the at least two locking elements 11, 11′ can in each case be displaced between a release position and a locking position. In the locked position, the at least two locking elements 11 in each case engage by means of the respective latching element 17 with a respective locking bolt 19 of the at least two locking bolts 19, so that the door element 7 is fixed relative to the cladding element 5. In the release position, the at least two locking elements 11′ release the respective locking bolt 19, so that the door element 7 can be displaced relative to the cladding element 5.

At least one of the locking elements 11, 11′ and the door handle device 23 are preferably connected to one another mechanically via at least one second rigid coupling element 21.2. The at least one first coupling element 21.1 and the at least one second coupling element 21.2 are connected to one another in such a way that a translation of the at least one second coupling element 21.2 effects a translation of the at least one first coupling element 21.1.

The at least one first rigid coupling element 21.1 is in each case preferably connected to a second end 15.2 of the respective locking element 11, 11′, which is located opposite the first 15.2 end of the respective locking element 11, 11′. A first distance d₁ between the first end 15.1 of the respective locking element 11 and the assigned fastening element 13 is thereby in each case smaller than a second distance d₂ between the second end 15.2 of the respective locking element 11 and the assigned fastening element 13.

The door handle 25 is preferably connected to the at least one second coupling element 21.2 in such a way that a pivoting of the door handle 25 effects a translation of the at least one second coupling element 21.2.

FIG. 3 shows a schematic illustration of a detail view of the exemplary embodiment of the charging station 1, in particular of the housing 3, from FIGS. 1 and 2, whereby the cladding element 5 is hidden.

A locking bolt 19 of the at least two locking bolts 19 is illustrated in FIG. 3.

The at least two locking elements 11 are in particular illustrated in the locking position in FIG. 3. The illustrated locking element 11 engages by means of the latching element 17 with the corresponding locking bolt 19, so that the door element 7 is fixed relative to the cladding element 5.

The door handle 25 is in particular furthermore locked in place in the door handle device 23.

FIG. 4 shows a schematic illustration of a detail view of the exemplary embodiment of the door lock 9 from FIGS. 1 to 3. FIG. 4 in particular shows a rear view of the door lock 9, whereby the locking element 11 is arranged in the locking position and the door handle 25 in the door locking position.

Analogously to FIG. 3, the cladding element 5 is hidden in FIG. 4.

The second rigid coupling element 21.2 is connected mechanically to a connecting element 31 of the door handle device 23 by means of a first screw 27.1 at a point of articulation 29. The door handle 25 is furthermore connected to the connecting element 31 by means of a second screw 27.2.

In the locking position of the locking elements 11 and in the door locking position of the door handle 25, the connecting element 31 in particular abuts on a protrusion 33. The protrusion 33 thereby limits a displacement of the connecting element 31 in one direction.

The second coupling element 21.2 is preferably fastened to the door handle device 23 in such a way that the point of articulation 29 of the second coupling element 21.2 is arranged on the door handle device 23 in a beyond dead center position when the door handle 25 is arranged in the door locking position.

The point of articulation 29 to the right of the dashed line 35 is in particular located in a beyond dead center position.

1. A housing, in particular for a charging station, comprising at least one cladding element and a door element, whereby
the at least one cladding element has a door lock comprising at least two locking elements, whereby
the at least two locking elements are spaced apart from one another and are arranged on the at least one cladding element so as to be capable of being rotated about a respective fastening element by means of the respective fastening element, whereby
on a first end of the respective locking element, the at least two locking elements have a latching element, whereby
the at least two locking elements are mechanically connected to one another via at least one first rigid coupling element, whereby
the at least two locking elements can in each case be displaced between a release position and a locking position, whereby
the door element has at least two locking bolts, whereby
in the locking position, the at least two locking elements engage by means of the respective latching element with a respective locking bolt of the at least two locking bolts, so that the door element is fixed relative to the cladding element, and whereby
in the release position, the at least two locking elements release the respective locking bolt, so that the door element can be displaced relative to the cladding element.

2. The housing according to claim 1, whereby the at least one first rigid coupling element is in each case connected to a second end of the respective locking element, which is located opposite the first end of the respective locking element, whereby a first distance (d₁) between the first end of the respective locking element and the assigned fastening element is in each case smaller than a second distance (d₂) between the second end of the respective locking element and the assigned fastening element.

3. The housing according to claim 1, whereby
the at least one cladding element additionally has a door handle device, whereby
at least one of the locking elements and the door handle device are mechanically connected to one another via at least one second rigid coupling element, whereby
the at least one first coupling element and the at least one second coupling element are connected to one another in such a way that a translation of the at least one second coupling element effects a translation of the at least one first coupling element.

4. The housing according to claim 1, whereby
the door handle device has a door handle, whereby
the door handle is pivotably arranged in the door handle device, whereby
the door handle is connected to the at least one second coupling element in such a way that a pivoting of the door handle effects a translation of the at least one second coupling element.

5. The housing according to claim 1, whereby the door handle can be displaced between a door release position and a door locking position, whereby during a pivoting of the door handle from the door locking position into the door release position, the at least two locking elements are in each case rotated from the locking position into the release position.

6. The housing according to claim 1, whereby the second coupling element is fastened to the door handle device in such a way that a point of articulation of the second coupling element on the door handle device is arranged in a beyond dead center position when the door handle is arranged in the door locking position.

7. A charging station comprising a housing according to claim 1.
